(19) United States
(12) Patent Application Publication
(10) Pub. No.: US 2026/0161793 A1
(43) Pub. Date: Jun. 11, 2026

(54) PHISHING IMPACT ASSESSMENT

(71) Applicant: Horizon 3 AI, Inc., Dover, DE (US)

(72) Inventors: Noah King, Wake Forest, NC (US); Naveen Naga Sunkavally, Cary, NC (US); John Tyler Orr, Raleigh, NC (US); Robert George Alderman, Lafayette, CO (US)

(21) Appl. No.: 18/973,537

(22) Filed: Dec. 9, 2024

(51) Int. Cl. G06F 21/57

(52) U.S. Cl. CPC G06F 21/577; G06F 2221/034

(57) ABSTRACT

An autonomous pentesting agent may obtain, based on a credential compromise test for a set of users of a network, a set of user credentials associated with the network, the set of user credentials being compromised by the credential compromise test. The autonomous pentesting agent may execute an autonomous penetration test of the network using the set of user credentials to gain access to one or more network assets of the network. The autonomous pentesting agent may output, based on the autonomous penetration test, a risk assessment report for the network, the risk assessment report indicating a blast radius associated with the set of user credentials compromised. Further, the blast radius may indicate an impact severity corresponding to the autonomous penetration test using the set of user credentials to gain the access to the one or more network assets.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support phishing impact assessment.

A method for credential compromise impact assessment by an apparatus is described. The method may include obtaining, based at least in part on a credential compromise test for a plurality of users of a network, a set of user credentials associated with the network, the set of user credentials being compromised by the credential compromise test, executing an autonomous penetration test of the network using the set of user credentials to gain access to one or more network assets of the network, and outputting, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

An apparatus for credential compromise impact assessment is described. The apparatus may include one or more memories storing processor executable code, and one or more processors coupled with the one or more memories. The one or more processors may individually or collectively be operable to execute the code to cause the apparatus to obtain, based at least in part on a credential compromise test for a plurality of users of a network, a set of user credentials associated with the network, the set of user credentials being compromised by the credential compromise test, execute an autonomous penetration test of the network using the set of user credentials to gain access to one or more network assets of the network, and output, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

Another apparatus for credential compromise impact assessment is described. The apparatus may include means for obtaining, based at least in part on a credential compromise test for a plurality of users of a network, a set of user credentials associated with the network, the set of user credentials being compromised by the credential compromise test, means for executing an autonomous penetration test of the network using the set of user credentials to gain access to one or more network assets of the network, and means for outputting, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

A non-transitory computer-readable medium storing code for credential compromise impact assessment is described. The code may include instructions executable by one or more processors to obtain, based at least in part on a credential compromise test for a plurality of users of a network, a set of user credentials associated with the network, the set of user credentials being compromised by the credential compromise test, execute an autonomous penetration test of the network using the set of user credentials to gain access to one or more network assets of the network, and output, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

### BRIEF DESCRIPTION OF THE DRAWINGS

FIG. 1 shows an example of a computing environment that supports phishing impact assessment in accordance with aspects of the present disclosure.

FIG. 2 shows an example of an autonomous pentest map that supports phishing impact assessment in accordance with aspects of the present disclosure.

FIG. 3 shows an example of a computing diagram that supports phishing impact assessment in accordance with aspects of the present disclosure.

FIGS. 4 and 5 show an example of an autonomous pentest map that supports phishing impact assessment in accordance with aspects of the present disclosure.

FIG. 6 shows a diagram of a system including a device that supports phishing impact assessment in accordance with aspects of the present disclosure.

FIG. 7 shows a flowchart illustrating methods that support phishing impact assessment in accordance with aspects of the present disclosure.

### DETAILED DESCRIPTION

In some examples, users of organizations may receive fraudulent messages that attempt to compromise user credentials. For example, a user may receive electronic messages (e.g., emails, messages, links, texts) as part of a phishing attack to attempt to steal data, information, credentials, or to gain access to a network. In some cases, phishing may be a form of cyber-attack where a fraudulent or malicious user pretends to be another user, brand, or company that a user may trust. For example, the phishing may be performed by a fraudulent user sending messages to users of an organization in an attempt to gain access to a set of user credentials from users of the organization and thereafter gain access to a network, gain access to data within the network, or perform other nefarious acts.

Security teams of organizations may have tools to identify credential compromise (e.g., phishing) attacks (e.g., external phishing attacks from an attacker outside of a network) and tools to test (e.g., periodically) users of the organization by initiating simulated phishing attacks (e.g., fake emails or scams that mimic a real phishing email or scam) in an attempt to better understand the security risks or the organization. In some cases, if a set of user credentials are phished or compromised (e.g., exploited in a phishing attack), security teams may be unable to determine the impact (e.g., the business impact) that a respective set of user credentials being compromised may have on the network. A security team may use a set of permissions for a user or a user’s credentials to gain an understanding of the potential impact on the network if compromised, but such permissions may be unable to illustrate the complete impact of an attack based solely on the permissions for a given user. For example, a security team may be unable to determine the true extent a user may have within a network based on the directory permissions configured for the user (e.g., the permissions configured or granted for a user within an identity and access management application or service associated with an organization). That is, some users may be misconfigured in the network or may have access to some services that the permissions allow but may not be readily apparent from the user permissions themselves, thus enabling users to exploit vulnerabilities in services on the network. Additionally, or alternatively, a user may have access to data or information within the network that could be used to gain access to another user’s credentials or other information, which could allow more access to information within a network that was unintended based on the permissions or configuration for the user. As such, these extents may not be considered by organizations when assessing an overall risk and impact of phished credentials. Further, having an incomplete view may result in security teams being inefficient in attempting to prevent phishing attacks (e.g., overemphasizing user education over fixing issues in the network).

Further, phishing attacks may become relatively more sophisticated, convincing, and complex by leveraging artificial intelligence (AI) tools. Additionally, or alternatively, fraudulent users (e.g., attackers) may use AI tools to perform adversary in the middle (AITM) attacks to attempt to bypass multi-factor authentication (MFA). Moreover, in some examples, training programs configured to educate users to detect phishing attacks may be relatively inefficient and outdated due to the increase in complexity and authenticity of phishing attacks due to the use of AI tools. Thus, security teams may expect that phishing is inevitable and should prepare for when (not if) users of an organization get phished.

The techniques of the present disclosure may assist security teams in determining a result of a phishing attack by implementing a phishing impact test that can be used to more accurately assess an overall risk of a network for a client when one or more sets of user credentials are phished, compromised, exploited, or any combination thereof. For example, a credential compromise test (e.g., a phishing test) may be performed for a user or a group of users of a network in an attempt to compromise user credentials or obtain other information that can be used to gain access to services, devices, servers, or other network assets. In some cases, based on the credential compromise test, a set of user credentials associated with the network may be compromised by credential compromise test. In response, an autonomous penetration testing (“pentesting”) agent as described herein may be used to execute an autonomous pentest to gain access to one or more network assets within the network using the set of user credentials (e.g., the compromised set of user credentials).

Based on executing the autonomous pentest, the autonomous pentesting agent may output a risk assessment report to indicate the impact that a credential compromise of the set of user credentials may have on the network. For example, the risk assessment report may indicate a blast radius associated with a set of user credentials being compromised. The blast radius may indicate an extent to which the set of user credentials that are compromised has access to the network. For example, the blast radius may indicate an impact severity that corresponds to the autonomous pentest using the set of user credentials to gain the access to the one or more network assets. That is, the impact severity may indicate the network assets and corresponding resources that can be accessed by using the set of user credentials that were compromised by the credential compromise test and an impact such access may have on the network. Thus, organizations may be capable of understanding security risks of networks and the impact a successful phishing attack may have on a network such that security teams can implement improvements to the network, user education on phishing, and prevention techniques to prevent phishing attacks from being successful in the future. Additionally, or alternatively, organizations may use risk assessment reports to audit user credentials, password terms, access of respective sets of user credentials. For example, the autonomous pentesting agent may determine that multiple users use similar terms within a password and the autonomous pentesting agent can suggest for an organization to implement a policy that prevents such terms from being used within a password among other requirements (e.g., longer passwords, more random passwords, and the like). Therefore, organizations may utilize the autonomous pentesting agent to generate risk assessment reports to improve the security of the network.

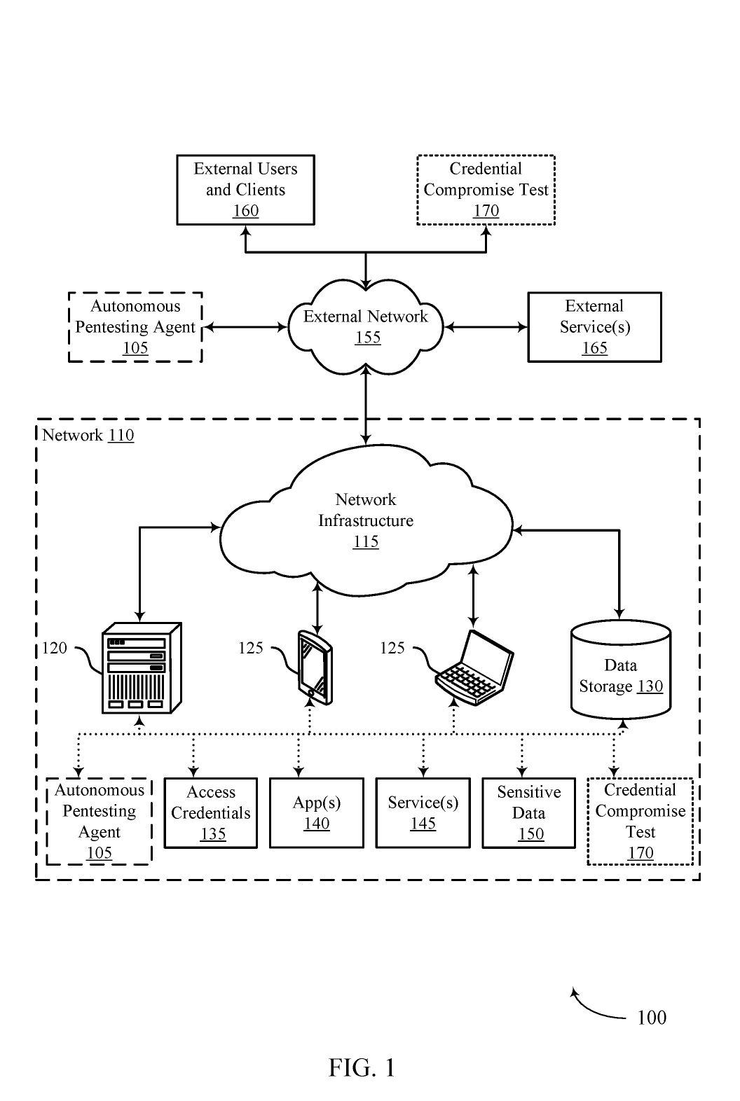

FIG. 1 illustrates an example of a computing environment 100 that supports phishing impact assessment in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. As used herein, network assets refer to machines that include network shares. For example, network assets may be examples of machines (e.g., real or virtual machines) that include shares of the network 110, such as file sharing systems. Network assets may be obtained and utilized by attackers to compromise the network 110. The server 120, the computing devices 125, the data storage 130, and the access credentials 135, app(s) 140, service(s) 145, and sensitive data 150 accessible via the devices and systems of the network 110 may all be examples of network assets. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

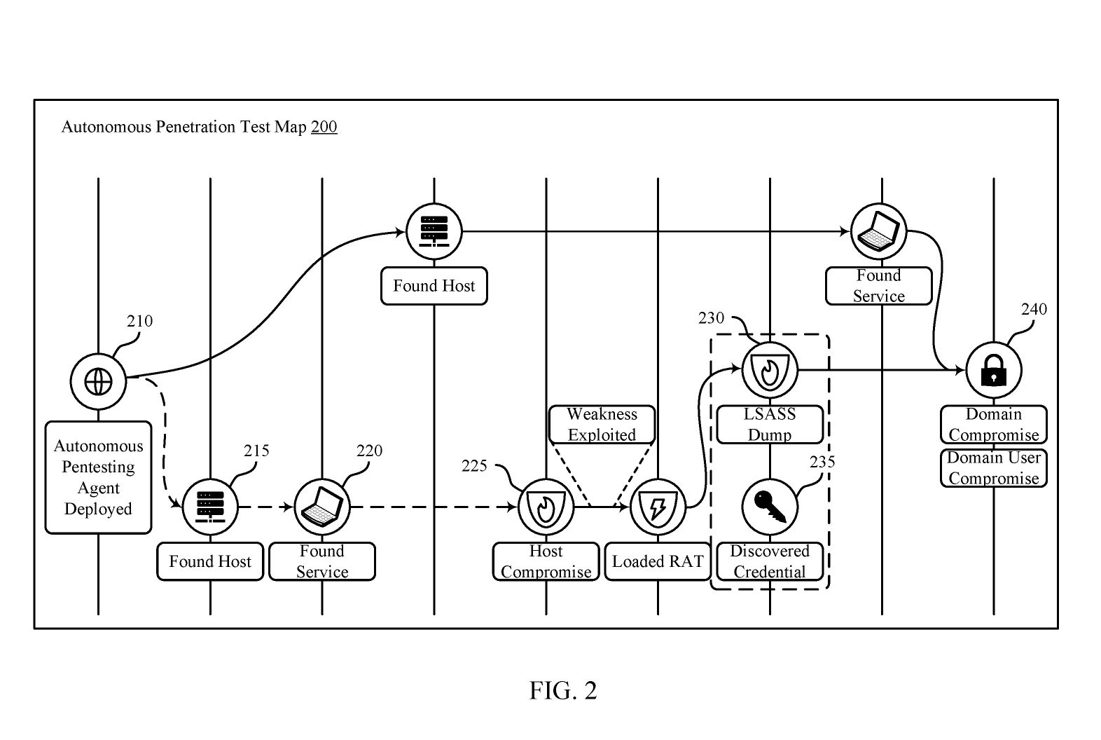

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, the autonomous pentesting agent 105 may be used to determine an impact of a credential compromise test 170. For example, the autonomous pentesting agent 105, external users and clients 160, external services 165, or any combination thereof, may execute a credential compromise test 170 to obtain a set of user credentials. The autonomous pentesting agent 105 may then utilize the set of user credentials within an autonomous pentest to gain access to one or more network assets (e.g., a server 120, computing devices 125, a data storage 130, access credentials 135, app(s) 140, service(s) 145, sensitive data 150, or any combination thereof) of the network 110. Further, the autonomous pentesting agent 105 may output a risk assessment report indicating a result of the credential compromise test 170 and an impact severity of the set of user credentials being compromised. By outputting the risk assessment report, users or organizations may be capable of determining one or more security risks of the network 110. For example, organizations may determine that additional users have access to the sensitive data 150 within the network 110, the access credentials 135 of users are incorrect, and the like and can perform procedures to adjust or modify the access for sets of user credentials. In some cases, a set of user credentials may also be removed from accessing one or more services 145 or from having access to sensitive data 150 based on an indication within the risk assessment report. Additionally, or alternatively, the risk assessment report may indicate one or more security vulnerabilities with the network 110 as a whole and an organization may implement one or more services 145 or applications 140 to enhance the security of the network 110.

FIG. 2 shows an example of an autonomous pentest map 200 that supports phishing impact assessment in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent.

The autonomous pentest map 200 may include one or more types of events. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent pay perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

In some examples, the autonomous pentesting service may obtain a set of user credentials from a credential compromise test. A credential compromise test may also be referred to as a phishing test elsewhere herein. In some cases, phishing may be a form of cyber-attack where someone pretends to be another user, brand, or company that a user may trust. In some examples, phishing may result in a set of user credentials being obtained and further used to gain access to data and additional information within a network. Further, when a fraudulent user gains access to a set of user credentials, the fraudulent user may perform one or more other cyber-attacks using the set of user credentials that are compromised.

Further, based on the set of user credentials being compromised by the credential compromise test, the deployment 210 of the autonomous pentesting agent may include using the set of user credentials to gain access to one or more network assets of a network. In some examples, the deployment 210 of the autonomous pentesting agent may be external to a client, internal to a client, or both. An internal deployment 210 may be associated with a client using a host within a network to run or execute the autonomous pentesting agent and the pentest may be executed by the client. An external deployment 210 may be associated with the autonomous pentesting agent operating on a cloud based service (e.g., an external cloud based service) and the autonomous pentesting agent may attempt to access or breach the network of the client through the internet.

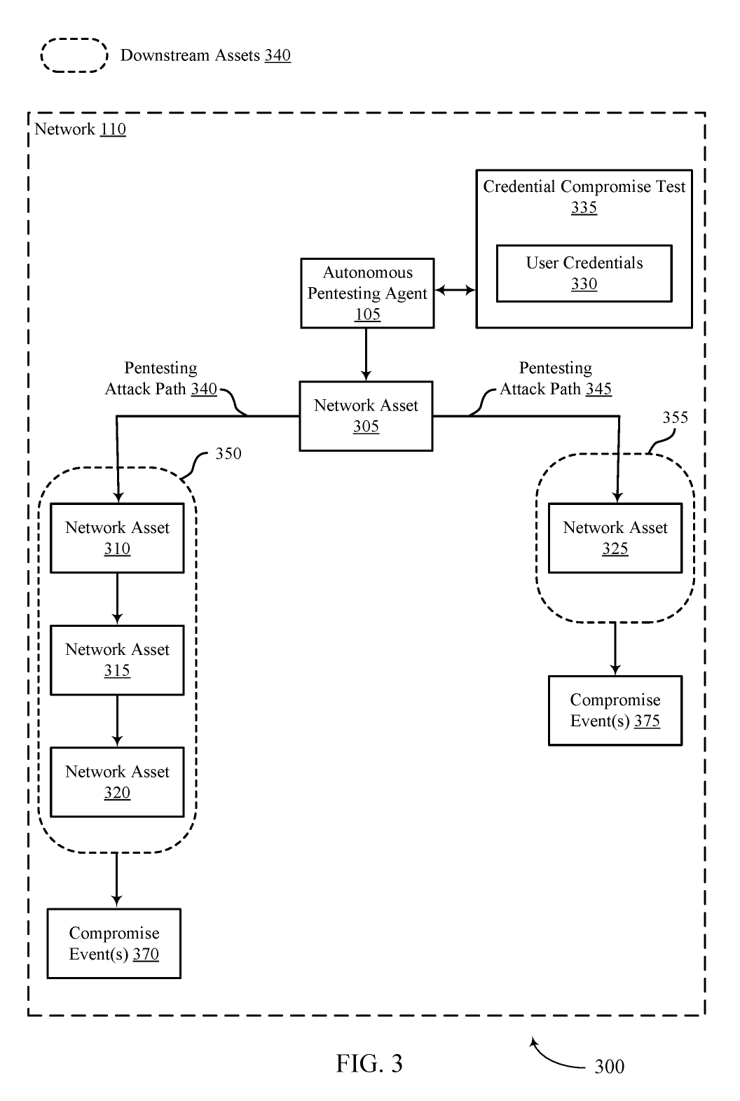

In some examples, after deployment 210 of the autonomous pentesting agent, internally, or externally, a host identification 215 event may occur using the set of credentials which may lead to a host compromise 225 event as illustrated via the autonomous pentest map 200. In some other examples, using the set of user credentials compromised by the credential compromise test, the autonomous pentesting agent may be capable of accessing data of an organization or a user. For example, the autonomous pentesting agent may gain access to data stored within a network file share, a database, a team collaboration software, or the like using the set of user credentials that are compromised. In another example, using the set of user credentials that are compromised by the credential compromise test, an access 240 event may occur indicating that the autonomous pentesting agent is capable of accessing and compromising a domain, a domain user, or both. Based on such events, the autonomous pentesting agent may further generate a risk assessment report to indicate a blast radius and impact severity of the set of user credentials being compromised by the credential compromise test. For example, the blast radius may be that access 240 is obtained and the impact severity may indicate whether the access 240 is associated with a domain compromise, a domain user compromise, or both, to indicate an extent of access that the set of user credentials has within a network. Further descriptions of an autonomous pentesting agent using a set of user credentials comprised by a credential compromise test for outputting a risk assessment report for the network may be described elsewhere herein, such as with reference to FIGS. 3 through 5.

FIG. 3 shows an example of a computing environment 300 that supports phishing impact assessment in accordance with aspects of the present disclosure. The computing environment 300 may implement or be implemented by the computing environment 100, the autonomous pentest map 200, or both. For example, the computing environment 300 may illustrate a network 110 that includes one or more network assets, including a network asset 305, a network asset 310, a network asset 315, a network asset 320, and a network asset 325. The network assets may be examples of one or more devices or systems described with reference to FIG. 1, including the server 120, computing devices 125, data storage 130, access credentials 135, app(s) 140, service(s) 145, or sensitive data 150. Further, in some cases, the app(s) 140 or service(s) 145 may be operated by third parties (e.g., software as a service (SaaS) applications or services). Moreover, in some examples, the sensitive data 150 may also be stored within a SaaS application or service. Additionally, the computing environment 300 may include an autonomous pentesting agent 105, which may perform an autonomous pentest of the network 110 using a set of user credentials 330 obtained based on a credential compromise test 335. Although the autonomous pentesting agent 105 is shown as internal to the network 110 in the computing environment 300 of FIG. 3, the autonomous pentesting agent 105 may alternatively be external to the network 110 and access the network 110 via the Internet or another external network.

In some examples, credential compromise test 335 (e.g., a phishing test) may be performed on a user or a set of users within the network 110 to attempt to obtain a set of user credentials 330. In some examples, the credential compromise test 335 may include performing simulated phishing attacks on users of the network 110. In some cases, a security team or third party (e.g., a penetration test service provider) may initiate and perform the credential compromise test 335 and send simulated phishing messages to the users of the network 110. In some other cases, a customized software application or service may enable a client a mechanism to send phishing messages (e.g., simulated fraudulent electronic messages such as emails). In some examples, a phishing message may be an email that encourages users to click on a link to obtain a set of user credentials 330 (e.g., plaintext credentials, username and password, multi-factor authentication (MFA) codes, and the like). For example, the email may include a message that is impersonating a reputable brand saying that the user had won a prize and the user must pay for shipping in order to receive the prize, a message that indicates a ‘failed’ payment and asks the user to click on a link to enter new payment information, or similar types of messages. In another example, the email may be an impersonation of a trusted employee of an organization, such as an information technology (IT) administrator, that asks for a user to login to a service or network asset and change a password before an expiration.

Once the user clicks on the link, a user may be led to a website that looks relatively identical to what the user would expect the website should look like. Within the website, one or more interactive text boxes may be included for the user to enter information. For example, the website may include interactive text boxes for the user to enter a set of user credentials to access a service or application. In some examples, to obtain the set of user credentials 330, the website may be embedded with a program to intercept the text within the interactive text boxes. In some other examples, the website may be embedded or edited to include one or more inline frames (iFrames) to access the set of user credentials 330. An iFrame may be used in a hypertext markup language (HTML) document to embed interactive media (e.g., login pages, pages to enter shipping addresses or payment information). As such, the website may have an iFrame that may be transparent to the user, and on the page where the user enters their login credentials the iFrame may be overlapping such that the user may give their user credentials to a fraudulent user instead of the person, organization, brand, business, or any combination thereof, that the fraudulent user may be impersonating.

In another example, a website may be embedded with a portion of JavaScript code. In some cases, using the JavaScript code, the fraudulent user or the autonomous pentesting agent 105 may be capable of logging all keystrokes entered within the website to exfiltrate sets of user credentials 330 or other sensitive information from a user. Additionally, or alternatively, the JavaScript code may be configured to send any information entered by a user (e.g., a set of user credentials 330) to an application programming interface (API) established for the credential compromise test 335. Further, using the JavaScript code, the fraudulent user or the autonomous pentesting agent 105 may be capable of controlling how the website reacts to user interaction and how the user can interact with the website.

For example, after a user enters their set of user credentials 330, the JavaScript code may trigger a display of a popup or message on the website to prompt the user that a username, a password, or both are incorrect. Such popup or message may then attempt to have the user input multiple different sets of user credentials 330 (e.g., multiple different username and password combinations or pairings). For example, users may frequently use similar passwords with relatively minor differences to access services and indicating to the user that an incorrect password was entered may prompt the user to believe that they have a different password for accessing a respective service or application. As such, a fraudulent user may be capable of obtaining multiple different sets of user credentials 330 via a single phishing message, thus resulting in potentially a relatively large quantity of sets of user credentials being compromised during a phishing campaign.

Once the set of user credentials 330 are obtained, the autonomous pentesting agent 105 may attempt to gain access to the network assets during an autonomous pentest using the set of user credentials 330 compromised by the credential compromise test 335. In some cases, the autonomous pentesting agent 105 may execute the credential compromise test 335 and then obtain the set of user credentials 330 from the results of performing the credential compromise test 335. In some other cases, a client or a third party may execute the credential compromise test 335 and then transmit the set of user credentials 330 compromised by the credential compromise test 335 to the autonomous pentesting agent 105 for the autonomous pentesting agent 105 to perform the autonomous pentest using the set of user credentials 330. During the autonomous pentest, the autonomous pentesting agent 105 may use the set of user credentials 330 to access network assets via one or more attack paths, including via a pentesting attack path 340 and via a pentesting attack path 345. For example, using the set of user credentials 330 compromised by the credential compromise test 335, the autonomous pentesting agent 105 may attempt to login to different service, compromise host devices, or gain access to data within the network 110 (e.g., confidential data or user information associated with a client, a user, the network 110, or any combination thereof). While two attack paths are illustrated in the example of FIG. 3, it may be understood that the autonomous pentesting agent 105 may follow any quantity of attack paths during the autonomous pentest.

The attack paths may illustrate how the autonomous pentesting agent 105 uses the set of user credentials 330 to access different assets within the network 110 during the autonomous pentest. For example, the autonomous pentesting agent 105 may use the set of user credentials 330 to access the network asset 305. Based on (e.g., during or after) accessing the network asset 305, the autonomous pentesting agent 105 may use the set of user credentials 330 to access the network asset 310 and the network asset 325. The autonomous pentesting agent 105 may access the network asset 315 based on accessing the network asset 310 and, finally, access the network asset 320 based on accessing the network asset 315. The network assets 310, 315, 320, and 325 may be considered “downstream” from the network asset 305.

In some examples, the pentesting attack paths may lead to compromise event(s). For example, the pentesting attack path 340 (e.g., assets 350) may lead to the compromise event(s) 370, and the pentesting attack path 345 (e.g., assets 355) may lead to the compromise event(s) 375. Compromising any of the network assets within a given attack path may lead to a compromise event in that attack path. The compromise events may be examples of the compromise events described with reference to FIG. 2. For example, the compromise events may be examples of host compromise, discovered credentials, deployment of attacker tools, domain compromise, domain user compromise, root access being obtained, access to a secured shell (SSH), a file transfer protocol (FTP), or both to transfer files stored in the network 110, or the like.

In some other examples, the pentesting attack paths may also lead to the autonomous pentesting agent 105 may performing attacks such as an account takeover (ATO) attack, a credential stuffing attack, session hijacking, distributed denial-of-service (DDoS) attacks, and the like. In some examples, a credential stuffing attack may include using the set of user credentials 330 along with a list of other sets of user credentials to attempt to gain access to an application, service, or sensitive data stored in the network 110. For example, as described herein, the credential compromise test 335 may trick users into inputting multiple sets of user credentials and the autonomous pentesting agent 105 may use each set of user credentials 330 to attempt to gain access to one or more network assets.

Further, in some examples, to perform an ATO, the autonomous pentesting agent 105 may perform or execute a session hijacking procedure. A session hijacking procedure may include a connection that is supposed to be being used between a user and the network 110 being hijacked. For example, a computing device 125 and the network 110 may form a connection via a handshake procedure. As there may be multiple connections between the network 110 and computing devices 125, messages exchanged between a computing device 125 and the network 110 may include information associated with a respective connection (e.g., a source IP address, a destination IP address, a source port number, and a destination port number). In some examples, the autonomous pentesting agent 105 may spoof a message to obtain the information of a respective connection between a computing device 125 and the network 110 and transmit the spoofed message to the network 110. As the autonomous pentesting agent 105 may have the correct information, the network 110 may be unable to determine that the spoofed message is from the autonomous pentesting agent 105 opposed to from the user associated with the connection. As such, the autonomous pentesting agent 105 or a fraudulent user may gain access to the connection and may be capable of redirecting the connection directly to the fraudulent user to gain complete access to a user’s account. Further, a DDoS attack may include a fraudulent user attempting to disrupt the service of the network 110 by flooding the network 110 with messages. For example, once the autonomous pentesting agent 105 gains access to the network using a set of user credentials 330 compromised by the credential compromise test 335, the autonomous pentesting agent may transmit a relatively large quantity of messages to the network 110 in an attempt to overwhelm the network 110. In some cases, once the network 110 is overwhelmed some security measures may be unable to prevent additional attacks due to a lack of resources within the network 110, thus resulting in the network 110 being unsecure. Moreover, in some examples, the autonomous pentesting agent 105 may obtain session tokens, access tokens, or both for network assets from users. The autonomous pentesting agent 105 may then use the session or access tokens of a user to gain access to the network 110 and network assets.

As used herein, “impact” may be referred to as an outcome an attacker may achieve by exploiting a set of weaknesses or misconfigurations. As an example, a vulnerability on a network asset (e.g., a domain controller) may be exploited by an attacker to compromise the network 110 (e.g., obtain full domain compromise). In such an example, the compromise may be the impact of the vulnerability on the network asset. Impact may be used to translate a technical issue or vulnerability to a potential business impact. The impact may be relevant to scoring or ranking various vulnerabilities, misconfigurations, and other deficiencies that led to the impact. In some examples, “impact” may be simply accessing the network assets or, in some other examples, “impact” may refer to a compromise event that occurs based on gaining access. Further, an impact may refer to the autonomous pentesting agent 105 gaining access to a set of user credentials 330 to thus enable the autonomous pentesting agent 105 the ability to login to network assets, the autonomous pentesting agent 105 the ability to be viewed as a trusted user using the set of user credentials 330. Moreover, such capabilities may be able to impact organizations or businesses without any common vulnerabilities and exposures (CVEs), misconfigurations, or the like. Examples of different impacts may be provided in greater detail elsewhere herein.

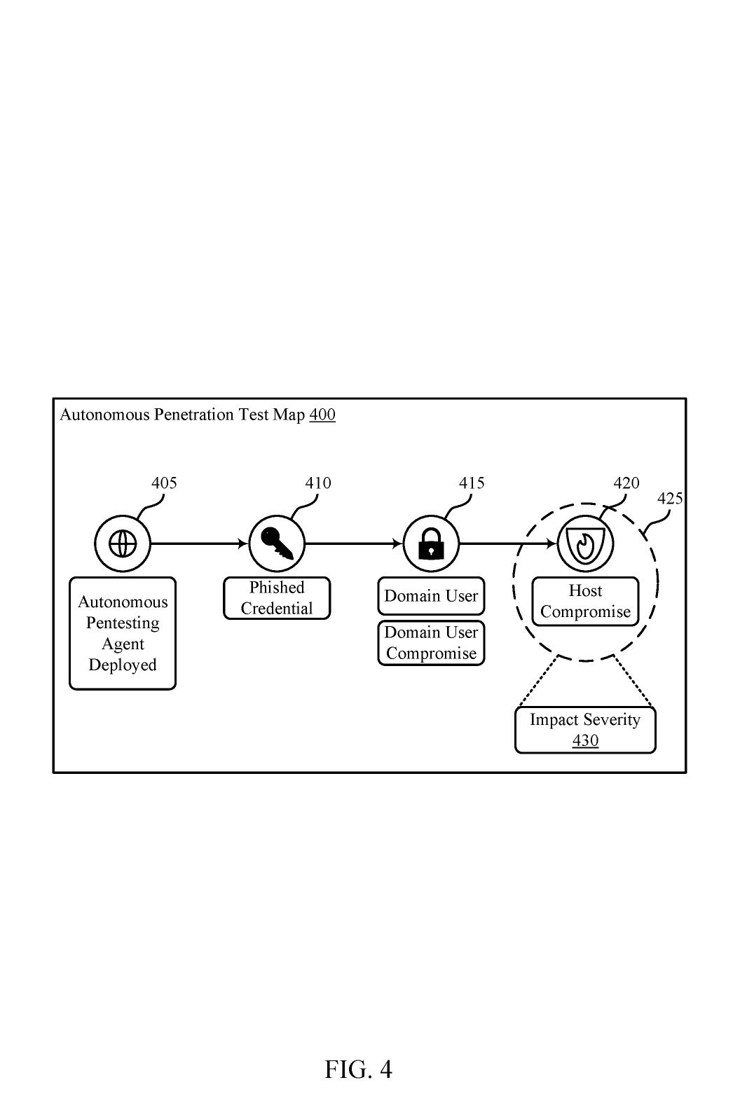

In some examples, the impact of the set of user credentials 330 being compromised may be determined by the autonomous pentesting agent 105. For example, the autonomous pentesting agent 105 may determine the impact of the credential compromise test 335 by generating a risk assessment report for the network that indicates a blast radius associated with the set of user credentials 330 compromised by the credential compromise test 335. Further, the blast radius may indicate an impact severity corresponding to the autonomous pentest using the set of user credentials 330 to gain access to the one or more network assets of the network 110. Thus, once the set of user credentials 330 are obtained, the autonomous pentesting agent 105 may determine a blast radius on a per user basis by using the set of user credentials 330 of a respective user to login to different services or to perform network attacks to gain access to confidential data of the client or the network 110. Further descriptions of an autonomous pentesting agent 105 being deployed using a set of user credentials 330 to access one or more network assets to determine a blast radius and impact severity may be described elsewhere herein, such as with reference to FIG. 4.

Moreover, in some cases, for each set of user credentials 330, regardless of an initial configuration, the blast radius associated with the set of user credentials 330 that is indicated within a risk assessment report may indicate an impact severity or extent of the set of user credentials 330 being compromised. In some examples, the impact severity corresponding to the autonomous penetration test using the set of user credentials 330 to gain the access to the one or more network assets may indicate a level of access to the one or more network assets of the network 110 associated with the set of user credentials 330 compromised by the credential compromise test 335. Moreover, in some cases, the level of access associated with the set of user credentials 330 may be different than a configured level of access associated with the set of user credentials 330. For example, while a set of user credentials 330 of the network 110 may be authorized with one or more user permissions for accessing services or devices within the network 110, the network 110 may have misconfigurations of user permissions. Thus, the set of user credentials 330 may be allowed to access additional network assets than initially configured. For example, the set of user credentials 330 may be associated with a low level member of a team but due to a misconfiguration the set of user credentials 330 may be associated with a level of access that is different from a configured level of access (e.g., a level of access that grants the set of user credentials 330 access to additional network assets). In some cases, the level of access may thus enable the autonomous pentesting agent 105 to use the set of user credentials 330 to access relatively more network assets of the network 110 than the set of user credentials 330 were originally or initially configured to access. Therefore, the blast radius and corresponding impact severity of the set of user credentials 330 being compromised by the credential compromise test 335 may be relatively larger than expected (e.g., the set of user credentials 330 may have access to more network assets than expected)

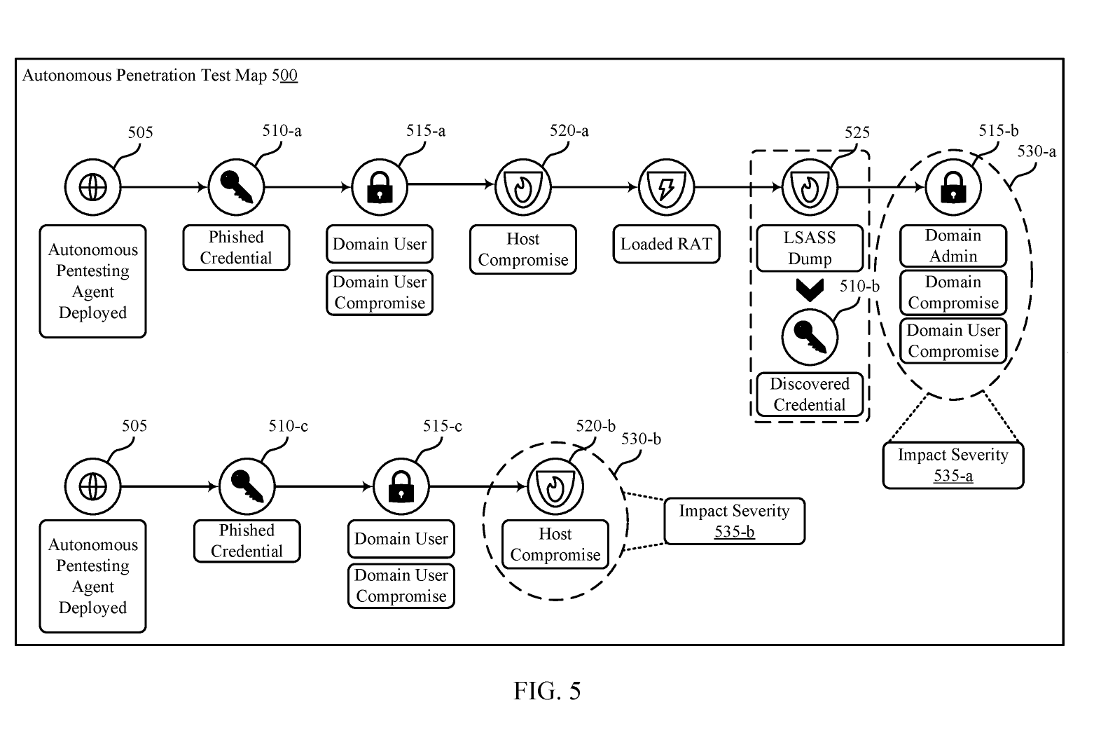

In some other cases, the set of user credentials 330 compromised by the credential compromise test 335 may have local or domain rights or permissions to the network 110, thus the autonomous pentesting agent 105 or an attacker (e.g., a fraudulent user performing a phishing attack) may be capable of accessing other sets of user credentials 330 to login and access other network assets using the set of user credentials 330 compromised by the credential compromise test 335. For example, the set of user credentials 330 may have local admin rights on one or more hosts and the autonomous pentesting agent 105 or an attacker can use the admin privileges of the set of user credentials 330 to access other sets of user credentials on the one or more hosts that the set of user credentials 330 has admin rights for. In another example, the set of user credentials 330 compromised by the credential compromise test 335 may have access to one or more files within the network 110 that include business critical data, user credentials, or other sensitive information that can result in the autonomous pentesting agent 105 gaining access to other systems or sets of user credentials. Further description of the autonomous pentesting agent 105 using multiple sets of user credentials for an autonomous pentest may be described elsewhere herein, such as with reference to FIG. 5.

In some cases, the autonomous pentesting agent 105 may utilize the extent to which the set of user credentials 330 compromised by the credential compromise test 335 has access within the network 110 to generate the risk assessment report for the network 110 that indicates an impact severity via the blast radius of the set of user credentials 330 being compromised. In some examples, the risk assessment report may also indicate the one or more network assets of the network 110 that the autonomous pentesting agent 105 is capable of accessing by performing the autonomous penetration test using the set of user credentials. Further, in some cases, the network 110 may include a set of network assets that includes a first network asset (e.g., the network asset 305) and the one or more network assets accessed by the autonomous pentesting agent 105 using the set of user credentials 330 may include the first network asset.

Additionally, or alternatively, the set of network assets of the network 110 may include a set of network assets that are downstream from the first network asset. For example, using the set of user credentials 330, the autonomous pentesting agent 105 may access at least one network asset that is downstream from the first network asset and the impact severity indicated via the blast radius may correspond to the at least one network asset accessed by autonomous pentesting agent 105. Additionally, or alternatively, the autonomous pentesting agent 105 accessing any of the set of network assets in the network 110 may result in a critical infrastructure compromise, a domain compromise, a domain user compromise, a host compromise, a perimeter breach, a sensitive data exposure, a brand compromise, a ransom ware exposure, a cloud service compromise, a cloud compromise, a business email compromise, a user or role compromise, a full account compromise, a directory user compromise, a full tenant compromise, a third-party user compromise, or any combination thereof.

In some examples, the credential compromise test 335 may also be used to determine a likelihood that a set of user credentials 330 can be compromised (e.g., a likelihood that a user could get phished). For example, once a user enters the set of user credentials 330 in response to a credential compromise test 335, the user may be relatively more likely to have their user credentials compromised in the future. Thus, the autonomous pentesting agent 105 may generate an aggregated list of the sets of user credentials 330 that are compromised from credential compromise tests 335 (e.g., the set of user credentials 330 compromised over multiple credential compromise tests 335 that are valid sets of user credentials) and the same set of user credentials 330 may appear multiple times within the historical data thus indicating that the set of user credentials 330 are at risk of being compromised during a phishing attack. Further, the autonomous pentesting agent 105 may indicate a risk of a respective set of user credentials 330 being compromised as a likelihood of exploitation of the respective set of user credentials 330 being compromised multiplied by an impact of such exploitation (e.g., the blast radius of the respective set of user credentials 330). Additionally, or alternatively, the likelihood that a respective user may enter a set of user credentials 330 in a credential compromise test 335 (e.g., a phishing test) may be indicated on a per-user basis, an organizational basis, or per business units (e.g., teams) of an organization. For example, to increase the levels of granularity for assessing risk, the autonomous pentesting agent 105 may determine a likelihood that one or more teams or groups of users within an organization may have a set of user credentials 330 compromised by the credential compromise test 335. Further in some examples, the autonomous pentesting agent 105 may output, via the risk assessment report, an indication of a likelihood of one or more sets of user credentials 330 being compromised via a credential compromise attack. Moreover, the indication of the likelihood of the one or more sets of user credentials 330 being compromised may be based on whether the one or more sets of user credentials 330 are compromised by the credential compromise test 335.

Moreover, in some cases, based on an indication of the likelihood of one or more sets of user credentials 330 being compromised, the autonomous pentesting agent 105 may determine a downstream impact of an organization or network being subject to a phishing attack. The downstream may be an outcome achieved indirectly by stringing together a series of weaknesses or misconfigurations into an attack chain that ultimately leads to an impact. In the example of FIG. 3, the downstream impact may be the compromise event(s) that occur based on gaining access to various network assets in the pentesting attack paths. As an example, a user credential (e.g., login information) may be compromised to give an attacker initial access to the network 110. Using the user credential and the initial access, the attacker may exploit other weaknesses in the network 110 that may lead to further compromises and, eventually, to compromise event(s) (e.g., full domain compromise). In this example, the compromise event(s) impact is downstream of the initial network access.

In some examples, using the blast radius and likelihood that a set of user credentials 330 can be compromised, the autonomous pentesting agent 105 may be capable of generating a relatively more accurate assessment of the impact that a set of user credentials 330 compromised by the credential compromise test 335 could have on the network 110. In some cases, attack paths can be built out showing a dependency tree which represents the downstream impact of one or more set of user credentials 330 compromised by the credential compromise test 335. For instance, each node in the dependency tree may be assigned a score and the nodes downstream from a set of user credentials 330 compromised by the credential compromise test 335 may be used to determine the blast radius and a corresponding score if the set of user credentials 330 are compromised by the credential compromise test 335. In some cases, the score may be determined by totaling the individual scores for each downstream node or the score of a downstream node with the highest score may be used to indicate the blast radius.

Further, the autonomous pentesting agent 105 may determine a total downstream impact for a weakness by modeling the pentesting attack paths. For example, the autonomous pentesting agent 105 may model the pentesting attack path 340 and the pentesting attack path 345 as directed acyclic graphs (DAGs). In the DAGs, the nodes of the graph may represent assets and findings from the pentest, such as hosts, credentials, vulnerabilities, impacts, and other finding types. The edges of the DAGs may represent attack-chain dependencies between the nodes. For example, if a vulnerability is found on a host, then a dependency edge may be drawn from the vulnerability node to the host node, indicating that the discovery of the vulnerability depended first on the discovery of the host. In other words, the autonomous pentesting agent 105 may model dependencies between different network assets, weaknesses, and compromises that are in the pentesting attack paths in DAGs.

In some examples, the autonomous pentesting agent 105 may combine models of different attack paths into a single model. For example, the autonomous pentesting agent 105 may combine a model of the pentesting attack path 340 with a model of the pentesting attack path 345 to obtain a model of the autonomous pentest as a whole. Such a model may be referred to as a merged model or a merged DAG. The autonomous pentesting agent 105 may use the merged DAG to determine a total downstream impact for any given node. For example, the autonomous pentesting agent 105 may follow the edges of the merged model to all impacts discovered by the autonomous pentesting agent 105 that are downstream from the node. In the example of FIG. 3, the autonomous pentesting agent 105 may use the merged model to identify that the network asset 305 has a downstream impact of the network asset 310, the network asset 315, the network asset 320, the compromise event(s) 370, the network asset 325, and the compromise event(s) 375.

Further, the network assets and the compromise event(s) may be associated with respective scores. The scores may be indicative of weakness scores or risk scores. In some examples, weakness scores and risk scores may be used interchangeably to refer to a level of security vulnerability of a network asset or a compromise event. Additionally, or alternatively, weakness scores may be understood as how easily the autonomous pentesting agent 105 gained access to a respective asset, while risk scores may be understood as how detrimental access to assets or occurrence of compromise event(s) are or would be to the network 110.

In some cases, the autonomous pentesting agent 105 may calculate downstream scoring for determining an impact severity of the autonomous pentesting agent 105 using the set of user credentials 330 via the totality of downstream nodes or a score (e.g., a maximum score) of the downstream nodes. Moreover, the autonomous pentesting agent 105 may use the downstream scoring to illustrate the additive risk to a client relative to a baseline risk. A baseline risk may be the risk of an attacker accessing the network 110 without a set of user credentials 330. For example, the baseline risk may indicate an impact or risk when an unauthenticated user gains access to the network 110 or observes network assets on the Internet. Thus, the baseline risk may indicate what an attacker can do to the network 110 and what an attacker can access from the network 110 without any sets of user credentials 330. In some examples, the baseline risk may also indicate how likely an attacker may be capable of obtaining a set of user credentials 330 by accessing the network 110.

In some examples, the downstream scoring may also determine an impact severity (e.g., a level of impact or risk) of any set of user credentials 330 being compromised and the capabilities of the autonomous pentesting agent 105 using the set of user credentials 330 with minimal permissions. Moreover, the downstream scoring may also be capable of indicating an impact severity for a respective set of user credentials 330. For example, when the set of user credentials 330 are compromised by the credential compromise test 335, the autonomous pentesting agent 105 may perform the autonomous pentest using the set of user credentials 330 to illustrate the additional risk of the set of user credentials 330 being compromised. Therefore, the risk assessment report may be capable of indicating, a baseline level of risk of the network 110, an additional level of risk of any set of user credentials 330 being compromised, and a further level of risk if a respective set of user credentials 330 or multiple sets of user credentials 330 are compromised. Moreover, the risk assessment report may indicate a comparison between two or more of the baseline level of risk, the additional level or risk, and the further level of risk.

Utilizing the risk assessment report, an organization may be capable of determining a course of action of mitigating risk to the network 110. For example, if the baseline risk is relatively high, implementing preventive measures against credential compromise attacks (e.g., phishing attacks) may be relatively inefficient since attackers may be capable of accessing a relatively large quantity of information or data by simply accessing the network 110 without a set of user credentials 330. In such cases, implementing additional security measures for the network 110 to prevent users from accessing network assets without any set of user credentials 330 may be relatively efficient. In another example, if the risk of any set of user credentials 330 being compromised is relatively high, the risk of a respective set of user credentials 330 being compromised is relatively high, or both, implementing preventive measures against credential compromise attacks may be relatively efficient. Further, to indicate the risk of a respective set of user credentials 330 being compromised, the autonomous pentesting agent 105 may output, via the risk assessment report for the network 110, an overall risk score corresponding to the set of user credentials. Moreover, the overall risk score may indicate the impact severity corresponding to the autonomous pentest test using the set of user credentials 330 to gain the access to the one or more network assets based at least in part on the set of user credentials 330 being compromised by the credential compromise test 335. Additionally, or alternatively, each network asset accessible by the set of user credentials 330 may be associated with a respective individual risk score.

In some cases, the autonomous pentesting agent 105 may indicate multiple risk scores via the risk assessment report. For example, the autonomous pentesting agent 105 may include a risk score associated with an attacker accessing the network 110, a risk score of any set of user credentials 330 being compromised, a risk score for a respective set of user credentials 330 being compromised, or any combination thereof. Further, in some cases the risk score for any set of user credentials 330 being compromised may be an average risk score that is calculated based on determining a risk score for multiple respective sets of user credentials 330 being compromised. Additionally, or alternatively, the risk assessment report may indicate one or more separate risk scores, an overall risk score that is an average of the risk score for an attacker accessing the network 110 without any set of user credentials 330, the risk score of any set of user credentials 330 being compromised. and the risk score of a respective set of user credentials 330 being compromised, or both.

In some examples, tracking the likelihood and blast radius (which shows impact) may be used to determine the risk scores over time. After identifying the true impact based on the credential compromise test 335, the autonomous pentesting agent, a user, or both may determine options for reducing likelihood and reducing the blast radius (e.g., on a per user basis). For instance, the credential compromise test 335 may identify respective users or sets of user credentials that are relatively more likely to get phished or have the most permissions within a network. Such users may be associated with relatively higher risk assessment and reducing the impact of phished credentials for such users may reduce the overall risk score and thus, the risk, to an organization or client. Further, based on the indications of a risk assessment report for the network 110, organizations or clients may be capable of determining how to efficiently reduce the overall risk to potential phishing attacks. For example, an organization may perform user education to reduce the likelihood of users being phished, or the organization may fix one or more issues within the network 110 to limit the impact of a set of user credentials being compromised. For example, the organization may fix one or more vulnerabilities and access misconfigurations (e.g., misconfigurations of permissions), adjust or adapt ineffective security controls, adjust relatively weak credentials and credential policies, or any combination thereof. Further descriptions of the techniques of the present disclosure where an autonomous pentesting agent 105 performs an autonomous pentest using a set of user credentials that are compromised may be described elsewhere herein, such as with reference to FIGS. 4 and 5.

FIG. 4 shows an example of an autonomous pentest map 400 that supports phishing impact assessment in accordance with aspects of the present disclosure. The autonomous pentest map 400 may implement or be implemented by the computing environment 100, the autonomous pentest map 200, or both. For example, autonomous pentest map 400 may illustrate an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent.

The autonomous pentest map 400 may include one or more types of events. For example, the autonomous pentest map 400 may include deployment 405 (e.g., of the autonomous pentesting agent), credential identification 410, access 415 (e.g., to a domain, a domain user, or both), and host compromise 420, The autonomous pentest map 200 includes one possible attack path that is generated based on an autonomous pentest. However, it is understood that any quantity of possible attack paths having any quantity of possible attack branches may be output from an autonomous pentest. In other words, the autonomous pentest map 400 may include one or more attack paths having one or more respective attack branches. In some cases, dozens, hundreds, or thousands of possible attack paths, branches, or both may be generated based on the autonomous pentest. Additionally, it is understood that while the autonomous pentest map 400 shown in FIG. 2 displays one example of an autonomous pentest for illustration, other maps including various different events, hosts, attack paths, and attack branches may result from various autonomous pentests.

In the example of the autonomous pentest map 400, the autonomous pentesting agent may identify an attack path using a set of user credentials compromised by a credential compromise test. As used herein, attack “path” may be understood to refer to a series of events, set in motion by the autonomous pentest agent, that lead to a compromise of one or more components or assets of a network. In some examples, as illustrated herein, after deployment 405 of the autonomous pentesting agent, the autonomous pentesting agent may perform a credential identification 410 and obtain a set of user credentials. In some cases, the credential identification 410 may represent a credential compromise test as described elsewhere herein. Further, the credential identification 410 may be performed by the autonomous pentesting agent or a third party service. If performed by a third party service, the autonomous pentesting agent may obtain the set of user credentials compromised by the credential compromise test from the third party service. Further, using the set of user credentials obtained via the credential identification 410 and compromised by the credential compromise test, the autonomous pentesting agent may gain access 415 to a domain user resulting in a domain user compromise. In some cases, a domain user compromise may indicate that the autonomous pentesting agent may gain access to a respective account of a domain user. For example, a domain user may have access to multiple network assets and the set of user credentials compromised by the credential compromise test may enable the autonomous pentesting agent to gain access to the network assets accessible to the domain user.

In some examples, the access 415 to a domain user that results in a domain user compromise may result in a host compromise 420. The host compromise 420 may indicate a compromise of a device within a network. For example, based on obtaining the set of user credentials via the credential identification 410 for a domain user and the access 415 that results in a domain user compromise, the autonomous pentesting agent may gain access to a device of the domain user resulting in the host compromise 420. In some cases, the host compromise 420 may enable the autonomous pentesting agent to gain access to sensitive information or data stored locally on the device of the domain user (e.g., a server 120, a computing device 125, or any other device connected to the network 110). Further, the autonomous pentesting agent may be capable of gaining access 415 to additional network assets via the device of the domain user. For example, a domain user may utilize a single sign-on (SSO) service that allows the user to access network assets (e.g., applications, services, and the like) using a respective device without providing any additional login credentials. Thus, the autonomous pentesting agent may gain access 415 to the additional network assets resulting in additional domain user compromises.

In some cases, after the host compromise 420, the autonomous pentesting agent may be unable to gain further access into the network beyond the domain user and the host of the domain user. Thus, when generating a risk assessment report for the network, the autonomous pentesting agent may indicate a blast radius 425 associated with the set of user credentials compromised. The blast radius 425 may indicate an impact severity 430 that corresponds to the autonomous pentest using the set of user credentials to gain access to the one or more network assets. That is, the impact severity 430 may indicate the extent to which the set of user credentials can access various services, data, or devices both within the network 110 and outside the network 110. Further, in some cases, the impact severity 430 indicated by the blast radius 425 of the set of user credentials being compromised may depend on a quantity data the set of user credentials can access, the type of data that the set of user credentials can access (e.g., whether sensitive or confidential data can be obtained using the set of user credentials), which services the set of user credentials are authorized for, and the like. Therefore, by generating the impact severity 430 and the blast radius 425 for the set of user credentials that are compromised by the credential compromise test, the autonomous pentesting agent may be capable of determining a relatively more accurate assessment of the impact of the set of user credentials being compromised.

In some examples, based on generating the risk assessment report that indicates the blast radius 425 and the impact severity 430 of the autonomous pentesting agent using a set of user credentials, an autonomous pentesting service may display the autonomous pentest map 400 such that compromised assets may be identified and security measures may be put in place. In some cases, the autonomous pentesting service may provide mitigation recommendations according to the autonomous pentest map 400. As an example, the autonomous pentest map 400 may identify a particular host or service as a security vulnerability for a network by tracing the access 415 backwards to a credential identification 410. Accordingly, the autonomous pentesting service may provide a mitigation recommendation to be applied to the host involved in the credential identification 410, such as according to how the host was identified or how access was obtained to the host at the host compromise 420. In some examples, the display of the autonomous pentest map 400 may also enable a client or organization to view a phishing likelihood impact and a risk plotted over a set of time across multiple credential compromise tests (e.g., phishing tests). Further, one or more metrics may also be displayed for a set of users, subsets of users (e.g., groups of teams within an organization), or for individual users.

Moreover, in some cases, in addition to displaying the autonomous pentest map 400, the autonomous pentesting service may display the set of actions for a set of users that are most likely to be phished to reduce an overall likelihood of users within an organization being phished. The autonomous pentesting service may also display an indication of a top set of weaknesses or issues within a network that can be fixed to reduce the impact of a phishing attack and potential solutions to the indicated issues. For example, the autonomous pentesting service may indicate that a relatively high quantity of users unnecessarily have administrative access to the network and can recommend for the organization to reduce the quantity of users that have administrative access as such users may have a relatively higher blast radius 425 and corresponding impact severity 430. Additionally, or alternatively, organizations may annotate such risk assessment reports that indicate trends with a set of mitigations implemented so the organization can determine which mitigation measures result in a reduction in risk of phishing attacks.

Thus, as illustrated herein, the blast radius 425 for the set of user credentials obtained via the credential identification 410 may be the host compromise 420 and the impact severity 430 may indicate the extent of information or access the autonomous pentesting agent can obtain based on the host compromise 420. In some cases, if the domain user compromised has relatively low levels of access to a network, the autonomous pentesting agent may be unable to access any sensitive data or additional sets of user credentials from the domain user compromise and the host compromise. In some other cases, if the domain user has a relatively high level of access to the network (e.g., the domain user is an administrator or has administrative privileges or permissions), the domain user compromise and the host compromise 420 may result in a relatively large quantity of network assets being accessed, additional sets of user credentials being compromised, or a combination thereof. For example, the domain user compromise, the host compromise, or both, may result in a second set of user credentials being compromised. Further descriptions of a second set of user credentials being compromised by a host compromise, a domain user compromise, or a credential compromise test, may be described elsewhere herein, such as with reference to FIG. 5.

FIG. 5 shows an example of an autonomous pentest map 500 that supports phishing impact assessment in accordance with aspects of the present disclosure. The autonomous pentest map 500 may implement or be implemented by the computing environment 100, the autonomous pentest map 200, or both. For example, autonomous pentest map 500 may illustrate an example of an output or result of an autonomous pentest performed by an autonomous pentesting agent, such as a pentest performed by the autonomous pentesting agent 105 in the network 110 as described with reference to FIG. 1. The autonomous pentest map 500 may illustrate and describe an example of events of a pentest, including operations performed by and information obtained by the autonomous pentesting agent.

The autonomous pentest map 500 may include one or more types of events. For example, the autonomous pentest map 500 may include deployment 505 (e.g., of the autonomous pentesting agent), credential identification 510, access 515 (e.g., to a domain, a domain user, or both), host compromise 520, and deployment of an attacker tool 525. The autonomous pentest map 500 may include two possible attack paths that are generated based on an autonomous pentest. However, it is understood that any quantity of possible attack paths having any quantity of possible attack branches may be output from an autonomous pentest. In other words, the autonomous pentest map 500 may include one or more attack paths having one or more respective attack branches. In some cases, dozens, hundreds, or thousands of possible attack paths, branches, or both may be generated based on the autonomous pentest. Additionally, it is understood that while the autonomous pentest map 500 shown in FIG. 5 displays two examples of an autonomous pentest for illustration, other maps including various different events, hosts, attack paths, and attack branches may result from various autonomous pentests.

In the example of the autonomous pentest map 500, the autonomous pentesting agent may identify an attack path using a set of user credentials compromised by a credential compromise test. As used herein, attack “path” may be understood to refer to a series of events, set in motion by the autonomous pentest agent, that lead to a compromise of one or more components or assets of a network. In some examples, as illustrated herein, after deployment 505-a of the autonomous pentesting agent, the autonomous pentesting agent may perform a credential identification 510-a and obtain a set of user credentials. In some cases, the credential identification 510-a may represent a credential compromise test as described elsewhere herein. Further, the credential identification 510-a may be performed by the autonomous pentesting agent or a third party service. Further, using the set of user credentials obtained via the credential identification 510-a and compromised by the credential compromise test, the autonomous pentesting agent may gain access 515-a to a domain user resulting in a domain user compromise. In some examples, the access 515-a to a domain user that results in a domain user compromise may result in a host compromise 520-a.

In some cases, on the compromised host, the autonomous pentesting agent may exploit a weakness identified on the service running on the host. Thus, the autonomous pentesting agent may perform a deployment of an attacker tool 525 to load a RAT and remotely control the compromised host. The autonomous pentesting agent may then perform, via the RAT, an LSASS dump, allowing the autonomous pentesting agent to discover a second set of user credentials via a credential identification 510-b. Therefore, the autonomous pentesting agent may obtain a second set of user credentials. Further, following the deployment of the attacker tool 525, the autonomous pentesting agent may gain access 515-b to a domain administrator resulting in a domain compromise and a domain user compromise. In some examples, a domain compromise may indicate a compromise of an entire network. For example, the deployment of the attacker tool 525 may result in the autonomous pentesting agent obtaining access to a set of user credentials for a domain administrator that is capable of accessing all network assets, services, data, or a combination thereof within a network.

Following the domain compromise, the autonomous pentesting agent may generate a risk assessment report for the network. For example, the autonomous pentesting agent may generate an indication of a blast radius 530-a associated with the set of user credentials compromised. The blast radius 530-a may indicate an impact severity 535-a that corresponds to the autonomous pentest using the set of user credentials to gain access to the one or more network assets. For example, as illustrated herein, the extent that the set of user credentials obtained via the credential identification 510-a may result in multiple domain user compromises, a host compromise 520-a that can result in the deployment of the attacker tool 525, and the access 515-b to the domain administrator resulting in a domain compromise. Thus, the impact severity 535-a of the autonomous pentesting agent using the set of user credentials may be relatively high due the amount of data accessible to the autonomous pentesting agent, the type of data accessible to the autonomous pentesting agent, the operations that the autonomous pentesting agent is capable of performing in the network (e.g., the deployment of the attacker tool 525), or any combination thereof.

In some examples, as described herein, the autonomous pentesting agent may obtain a second set of user credentials. For example, the credential compromise test may result in a second set of user credentials being compromised. Therefore, the autonomous pentesting agent may obtain a second set of user credentials and the autonomous pentesting agent may use the second set of user credentials as part of an autonomous pentest to gain access to one or more second network assets of the network. That is, the results of the credential compromise test may include the second set of user credentials. For example, the credential compromise test may be for multiple users of the network and at least two sets of user credentials may be compromised by the credential compromise test.

In another example, the second set of user credentials may be compromised by the autonomous pentest using the set of user credentials obtained via the credential identification 510-a. For example, as described herein, the deployment of the attacker tool 525 may enable the autonomous pentesting agent to perform the LSASS dump and gain access to one or more additional sets of user credentials (e.g., the second set of user credentials). Therefore, in some examples, the autonomous pentesting agent may perform a separate attack path using the second set of user credentials. For example, within a second attack path, after deployment 505-b of the autonomous pentesting agent, the autonomous pentesting agent may perform a credential identification 510-c and obtain the second set of user credentials. In some examples, if the second set of credentials are compromised by the credential compromise test, the credential identification 510-c may be the same as the credential identification 510-a. In some other examples, if the second set of user credentials are compromised by the deployment 505-a of the autonomous pentesting agent using the set of user credentials, the credential identification 510-c may be the same as the credential identification 510-b. Further, using the second set of user credentials obtained via the credential identification 510-c, the autonomous pentesting agent may gain access 515-c to a domain user resulting in a domain user compromise. In some examples, the access 515-c to the domain user that results in the domain user compromise may further result in a host compromise 520-b.

In some cases, after the host compromise 520-b, the autonomous pentesting agent may be unable to gain further access into the network beyond the domain user and the host of the domain user. Thus, when generating a risk assessment report for the network, the autonomous pentesting agent may indicate a blast radius 530-b associated with the second set of user credentials compromised. The blast radius 530-b may indicate an impact severity 535-b that corresponds to the autonomous pentest using the second set of user credentials to gain access to the one or more second network assets. Therefore, the autonomous pentesting agent may output an indication of the blast radius 530-b (e.g., a second blast radius) associated with the second set of user credentials via a risk assessment report. Further, the blast radius 530-b may indicate the impact severity 535-b (e.g., a second impact severity) that corresponds to the autonomous pentest using the second set of user credentials to gain access to the one or more second network assets. Further, in some examples, the one or more second network assets of the network accessible using the second set of user credentials may include at least one network asset different from the one or more network assets accessible using the set of user credentials.

Further, in some cases, the impact severity 535-a corresponding to the autonomous pentest using the set of user credentials may be based on the impact severity 535-b corresponding to the autonomous pentest using the second set of user credentials. For example, in some cases, the risk assessment report may indicate a single one of the blast radius 530 and the impact severity 535. In such cases, the impact severity 535-a may be based on the impact severity 535-b, or vice versa. In some other cases, the risk assessment report may indicate both the blast radius 530-a that indicates the impact severity 535-a and the blast radius 530-b that indicates the impact severity 535-b.

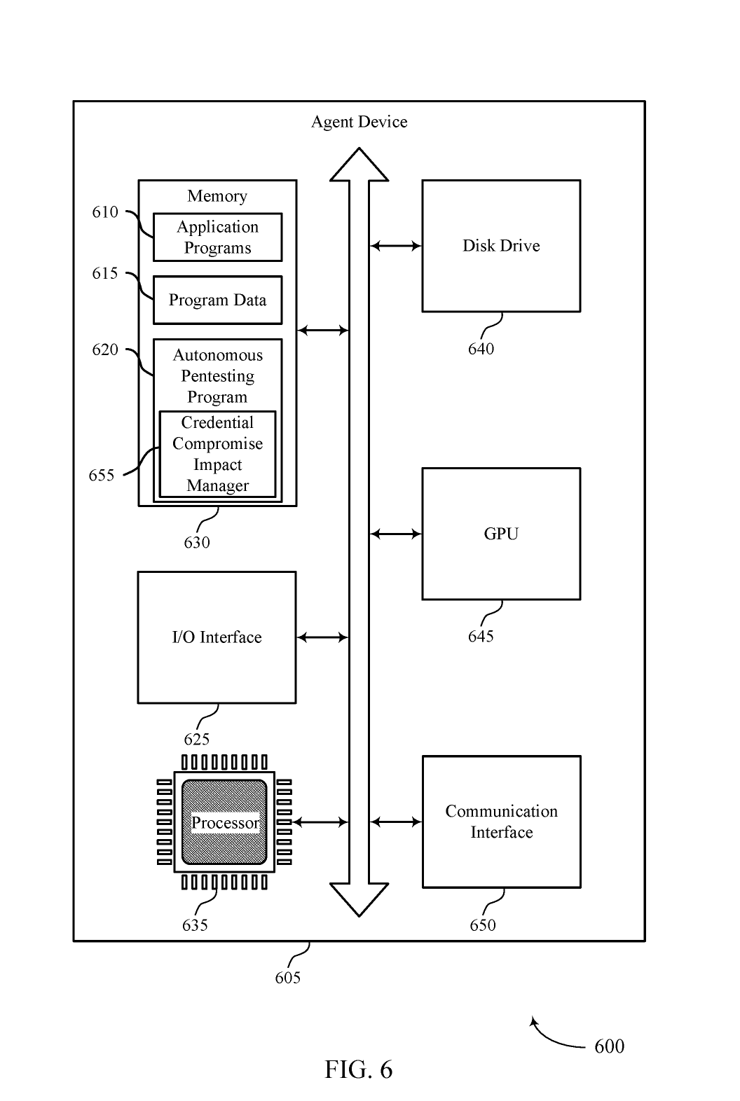

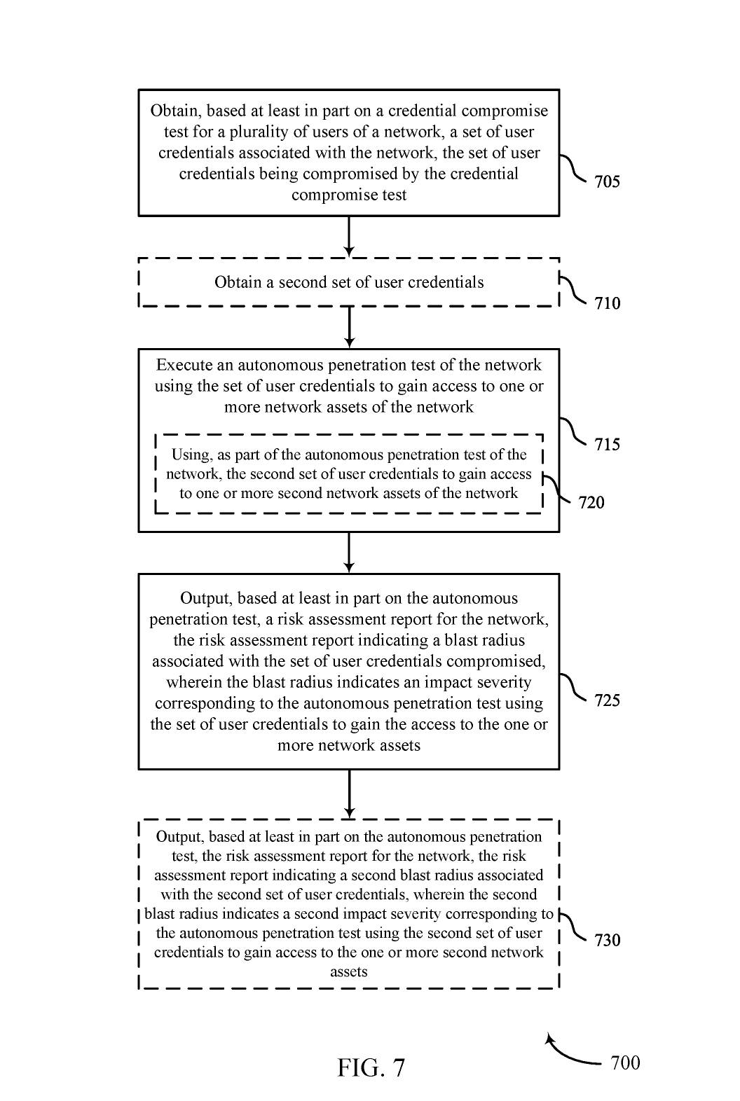

In some examples, based on generating the risk assessment report that indicates the blast radius 530-a and the impact severity 535-a, the blast radius 530-b and the impact severity 535-b, or both, an autonomous pentesting service may display the autonomous pentest map 500 such that compromised assets may be identified and security measures may be put in place. In some cases, the autonomous pentesting service may provide mitigation recommendations according to the autonomous pentest map 500. As an example, the autonomous pentest map 500 may identify a particular host or service as a security vulnerability for a network by tracing the access 515 backwards to a credential identification 410. Accordingly, the autonomous pentesting service may provide a mitigation recommendation to be applied to the host or domain involved in the credential identification 510. Thus, in accordance with the techniques of the present disclosure, organizations may be capable of using the risk assessment report to reduce the risk of potential phishing attacks thus improving the security and reliability of the network associated with the organization. Further descriptions of the techniques of the present disclosure may be described elsewhere herein, such as with reference to FIGS. 6 and 7.

FIG. 6 shows a diagram of a system 600 including an agent device 605 that supports phishing impact assessment in accordance with aspects of the present disclosure. The agent device 605 may be an example of a device or server on which an autonomous pentesting agent 105 is deployed as described herein. The agent device 605 may include components for phishing impact assessment, such as a memory 630 including application programs 610, program data 615, an autonomous pentesting program 620, and a credential compromise impact manager 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting phishing impact assessment. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting phishing impact assessment). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest involving autonomous deployment of tripwires.

The credential compromise impact manager 655 may support credential compromise impact assessment in accordance with examples as disclosed herein. For example, the credential compromise impact manager 655 may be configured as or otherwise support a means for obtaining, based on a credential compromise test for a set of users of a network, a set of user credentials associated with the network, the set of user credentials being compromised by the credential compromise test. The credential compromise impact manager 655 may be configured as or otherwise support a means for executing an autonomous penetration test of the network using the set of user credentials to gain access to one or more network assets of the network. The credential compromise impact manager 655 may be configured as or otherwise support a means for outputting, based on the autonomous penetration test, a risk assessment report for the network, the risk assessment report indicating a blast radius associated with the set of user credentials compromised, where the blast radius indicates an impact severity corresponding to the autonomous penetration test using the set of user credentials to gain the access to the one or more network assets.

By including or configuring the credential compromise impact manager 655 in accordance with examples as described herein, the agent device 605 may support techniques for improved network security.

FIG. 7 shows a flowchart illustrating a method 700 that supports phishing impact assessment in accordance with aspects of the present disclosure. The operations of the method 700 may be implemented by an agent device 705 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method may include obtaining, based at least in part on a credential compromise test for a plurality of users of a network, a set of user credentials associated with the network, the set of user credentials being compromised by the credential compromise test.

At 710, the method may include obtaining a second set of user credentials.

At 715, the method may include executing an autonomous penetration test of the network using the set of user credentials to gain access to one or more network assets of the network.

At 720, the method may include using, as part of the autonomous penetration test of the network, the second set of user credentials to gain access to one or more second network assets of the network.

At 725, the method may include outputting, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

At 730, the method may include outputting, based at least in part on the autonomous penetration test, the risk assessment report for the network, the risk assessment report indicating a second blast radius associated with the second set of user credentials, wherein the second blast radius indicates a second impact severity corresponding to the autonomous penetration test using the second set of user credentials to gain access to the one or more second network assets.

### The following provides an overview of aspects of the present disclosure

Aspect 1: A method for credential compromise impact assessment, comprising: obtaining, based at least in part on a credential compromise test for a plurality of users of a network, a set of user credentials associated with the network, the set of user credentials being compromised by the credential compromise test; executing an autonomous penetration test of the network using the set of user credentials to gain access to one or more network assets of the network; and outputting, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

Aspect 2: The method of aspect 1, further comprising: obtaining a second set of user credentials; using, as part of the autonomous penetration test of the network, the second set of user credentials to gain access to one or more second network assets of the network; and outputting, based at least in part on the autonomous penetration test, the risk assessment report for the network, the risk assessment report indicating a second blast radius associated with the second set of user credentials, wherein the second blast radius indicates a second impact severity corresponding to the autonomous penetration test using the second set of user credentials to gain access to the one or more second network assets.

Aspect 3: The method of aspect 2, wherein the one or more second network assets of the network includes at least one network asset different from the one or more network assets.

Aspect 4: The method of any of aspects 2 through 3, wherein the risk assessment report indicates both the blast radius associated with the set of user credentials and the second blast radius associated with the second set of user credentials.

Aspect 5: The method of any of aspects 2 through 4, wherein the second set of user credentials are compromised by the credential compromise test.

Aspect 6: The method of any of aspects 2 through 5, wherein the second set of user credentials are compromised by the autonomous penetration test using the set of user credentials.

Aspect 7: The method of aspect 6, wherein the impact severity corresponding to the autonomous penetration test using the set of user credentials is based at least in part on the second impact severity corresponding to the autonomous penetration test using the second set of user credentials.

Aspect 8: The method of any of aspects 1 through 7, wherein obtaining the set of user credentials comprises: executing the credential compromise test for the plurality of users of the network, wherein the set of user credentials are obtained based at least in part on executing the credential compromise test.

Aspect 9: The method of any of aspects 1 through 8, wherein outputting the risk assessment report comprises: outputting, via the risk assessment report, an indication of the one or more network assets of the network that are capable of being accessed by the autonomous penetration test using the set of user credentials.

Aspect 10: The method of any of aspects 1 through 9, wherein outputting the risk assessment report comprises: outputting, via the risk assessment report, an indication of a likelihood of one or more sets of user credentials being compromised via a credential compromise attack, the indication of the likelihood of the one or more sets of user credentials being compromised being based at least in part on whether the one or more sets of user credentials are compromised by the credential compromise test.

Aspect 11: The method of any of aspects 1 through 10, wherein outputting the risk assessment report comprises: outputting, via the risk assessment report, an overall risk score corresponding to the set of user credentials, wherein the overall risk score indicates the impact severity corresponding to the autonomous penetration test using the set of user credentials to gain the access to the one or more network assets based at least in part on the set of user credentials being compromised by the credential compromise test, wherein each network asset accessible by the set of user credentials is associated with a respective individual risk score.

Aspect 12: The method of any of aspects 1 through 11, wherein the impact severity corresponding to the autonomous penetration test using the set of user credentials to gain the access to the one or more network assets indicates a level of access to the one or more network assets of the network associated with the set of user credentials compromised by the credential compromise test.

Aspect 13: The method of aspect 12, wherein the level of access associated with the set of user credentials is different than a configured level of access associated with the set of user credentials.

Aspect 14: The method of any of aspects 1 through 13, wherein the set of user credentials are associated with a first user of the plurality of users of the network.

Aspect 15: The method of any of aspects 1 through 14, wherein the network comprises a plurality of network assets comprising a first network asset, the one or more network assets including the first network asset, the plurality of network assets comprising a set of network assets that are downstream from the first network asset, and the impact severity indicated via the blast radius corresponds to at least one network asset accessed by the autonomous penetration test using the set of user credentials that is downstream from the first network asset.

Aspect 16: The method of aspect 15, wherein the plurality of network assets comprises a critical infrastructure compromise, a domain compromise, a domain user compromise, a host compromise, a perimeter breach, a sensitive data exposure, a brand compromise, a ransom ware exposure, a cloud service compromise, a cloud compromise, a business email compromise, a user or role compromise, a full account compromise, a directory user compromise, a full tenant compromise, a third-party user compromise, or any combination thereof.

Aspect 17: An apparatus for credential compromise impact assessment, comprising one or more memories storing processor-executable code, and one or more processors coupled with the one or more memories and individually or collectively operable to execute the code to cause the apparatus to perform a method of any of aspects 1 through 16.

Aspect 18: An apparatus for credential compromise impact assessment, comprising at least one means for performing a method of any of aspects 1 through 16.

Aspect 19: A non-transitory computer-readable medium storing code for credential compromise impact assessment, the code comprising instructions executable by one or more processors to perform a method of any of aspects 1 through 16.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for credential compromise impact assessment, comprising:
obtaining, based at least in part on a credential compromise test for a plurality of users of a network, a set of user credentials associated with the network, the set of user credentials being compromised by the credential compromise test;
executing an autonomous penetration test of the network using the set of user credentials to gain access to one or more network assets of the network; and
outputting, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

2. The method of claim 1, further comprising:
obtaining a second set of user credentials;
using, as part of the autonomous penetration test of the network, the second set of user credentials to gain access to one or more second network assets of the network; and
outputting, based at least in part on the autonomous penetration test, the risk assessment report for the network, the risk assessment report indicating a second blast radius associated with the second set of user credentials, wherein the second blast radius indicates a second impact severity corresponding to the autonomous penetration test using the second set of user credentials to gain access to the one or more second network assets.

3. The method of claim 2, wherein the one or more second network assets of the network includes at least one network asset different from the one or more network assets.

4. The method of claim 2, wherein the risk assessment report indicates both the blast radius associated with the set of user credentials and the second blast radius associated with the second set of user credentials.

5. The method of claim 2, wherein the second set of user credentials are compromised by the credential compromise test.

6. The method of claim 2, wherein the second set of user credentials are compromised by the autonomous penetration test using the set of user credentials.

7. The method of claim 6, wherein the impact severity corresponding to the autonomous penetration test using the set of user credentials is based at least in part on the second impact severity corresponding to the autonomous penetration test using the second set of user credentials.

8. The method of claim 1, wherein obtaining the set of user credentials comprises:
executing the credential compromise test for the plurality of users of the network, wherein the set of user credentials are obtained based at least in part on executing the credential compromise test.

9. The method of claim 1, wherein outputting the risk assessment report comprises:
outputting, via the risk assessment report, an indication of the one or more network assets of the network that are capable of being accessed by the autonomous penetration test using the set of user credentials.

10. The method of claim 1, wherein outputting the risk assessment report comprises:
outputting, via the risk assessment report, an indication of a likelihood of one or more sets of user credentials being compromised via a credential compromise attack, the indication of the likelihood of the one or more sets of user credentials being compromised being based at least in part on whether the one or more sets of user credentials are compromised by the credential compromise test.

11. The method of claim 1, wherein outputting the risk assessment report comprises:
outputting, via the risk assessment report, an overall risk score corresponding to the set of user credentials, wherein the overall risk score indicates the impact severity corresponding to the autonomous penetration test using the set of user credentials to gain the access to the one or more network assets based at least in part on the set of user credentials being compromised by the credential compromise test, wherein each network asset accessible by the set of user credentials is associated with a respective individual risk score.

12. The method of claim 1, wherein outputting the risk assessment report comprises:
outputting, via the risk assessment report, a baseline risk score associated with the network, a first risk score for a respective set of user credentials associated any user of the plurality of users being compromised by the credential compromise test, a second risk score for a respective set of user credentials associated with a respective user of the plurality of users being compromised by the credential compromise test, or any combination thereof.

13. The method of claim 12, wherein outputting the risk assessment report comprises:
outputting, via the risk assessment report, a comparison between two or more of the baseline risk score, the first risk score, and the second risk score.

14. The method of claim 1, wherein outputting the risk assessment report comprises:
outputting a display of the risk assessment report, wherein the display of the risk assessment report comprises one or more indications of a likelihood of one or more sets of user credentials being compromised via a credential compromise attack, the blast radius and impact severity of one or more sets of user credentials compromised by the credential compromise test, one or more indications of a risk of one or more sets of user credentials, the network, or both, over two or more credential compromise tests, or any combination thereof.

15. The method of claim 1, wherein the impact severity corresponding to the autonomous penetration test using the set of user credentials to gain the access to the one or more network assets indicates a level of access to the one or more network assets of the network associated with the set of user credentials compromised by the credential compromise test.

16. The method of claim 15, wherein the level of access associated with the set of user credentials is different than a configured level of access associated with the set of user credentials.

17. The method of claim 1, wherein the network comprises a plurality of network assets comprising a first network asset, the one or more network assets including the first network asset, the plurality of network assets comprising a set of network assets that are downstream from the first network asset, and wherein the impact severity indicated via the blast radius corresponds to at least one network asset accessed by the autonomous penetration test using the set of user credentials that is downstream from the first network asset.

18. The method of claim 17, wherein the plurality of network assets comprises a critical infrastructure compromise, a domain compromise, a domain user compromise, a host compromise, a perimeter breach, a sensitive data exposure, a brand compromise, a ransom ware exposure, a cloud service compromise, a cloud compromise, a business email compromise, a user or role compromise, a full account compromise, a directory user compromise, a full tenant compromise, a third-party user compromise, or any combination thereof.

19. An apparatus for credential compromise impact assessment, comprising:
one or more memories storing processor-executable code; and
one or more processors coupled with the one or more memories and individually or collectively operable to execute the code to cause the apparatus to:
obtain, based at least in part on a credential compromise test for a plurality of users of a network, a set of user credentials associated with the network, the set of user credentials being compromised by the credential compromise test;
execute an autonomous penetration test of the network using the set of user credentials to gain access to one or more network assets of the network; and
output, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.

20. A non-transitory computer-readable medium storing code for credential compromise impact assessment, the code comprising instructions executable by one or more processors to:
obtain, based at least in part on a credential compromise test for a plurality of users of a network, a set of user credentials associated with the network, the set of user credentials being compromised by the credential compromise test;
execute an autonomous penetration test of the network using the set of user credentials to gain access to one or more network assets of the network; and
output, based at least in part on the autonomous penetration test, a risk assessment report for the network, the risk assessment report indicating a blast radius associated with the set of user credentials compromised, wherein the blast radius indicates an impact severity corresponding to the autonomous penetration test using the set of user credentials to gain the access to the one or more network assets.
